(19) United States
(12) Patent Application Publication
(10) Pub. No.: US 2013/0129268 A1
(43) Pub. Date: May 23, 2013

(54) SPINDLE MOTOR

(71) Applicants: Shin Young CHEONG, Suwon (KR); Ju Ho Kim, Seoul (KR); Chang Jo Yu, Suwon (KR)

(72) Inventors: Shin Young CHEONG, Suwon (KR); Ju Ho Kim, Seoul (KR); Chang Jo Yu, Suwon (KR)

(73) Assignee: SAMSUNG ELECTRO-MECHANICS CO., LTD., Suwon (KR)

(21) Appl. No.: 13/396,099

(22) Filed: Feb. 14, 2012

(30) Foreign Application Priority Data
Nov. 18, 2011 (KR) 10-2011-0120942

(51) Int. Cl. F16C 32/06

(52) U.S. Cl. 384/107

(57) ABSTRACT

There is provided a spindle motor including: a shaft having a lower end portion fixed into a base member; a thrust plate fixed to the shaft; an upper sleeve disposed above the thrust plate and forming a first bearing clearance with the shaft; a lower sleeve disposed below the thrust plate and forming a second bearing clearance with the shaft; and a rotor hub rotating together with the upper and lower sleeves, wherein the upper sleeve includes an extension part extended toward the lower sleeve, and the lower sleeve includes a clearance adjusting part disposed to face the extension part when being coupled to the upper sleeve and extended toward the upper sleeve.

### CROSS-REFERENCE TO RELATED APPLICATIONS

This application claims the priority of Korean Patent Application No. 10-2011-0120942 filed on Nov. 18, 2011, in the Korean Intellectual Property Office, the disclosure of which is incorporated herein by reference.

### BACKGROUND OF THE INVENTION

1. Field of the Invention

The present invention relates to a spindle motor.

2. Description of the Related Art

An information recording and reproducing device such as a hard disk driving device for a server, or the like, generally has a shaft-fixed type spindle motor mounted therein, in which a shaft having strong impact resistance is fixed to a case of the hard disk driving device.

That is, the shaft is fixedly installed in the spindle motor mounted in the hard disk driving device for a server, in order to prevent information stored in the server from becoming damaged and unrecordable/unreadable due to external impacts.

Meanwhile, since a spindle motor mounted in an enterprise hard disk driving device needs to have a high level of reliability, the development of a technology for improving the rotational characteristics of a spindle motor having a fixed type shaft has been urgently demanded.

In other words, the development of a technology for improving the rotational characteristics of a spindle motor by suppressing a rotor configuring the spindle motor from rotating while being inclined based on a shaft, has been urgently demanded.

To this end, a thrust plate may be fixedly installed on a central portion of the shaft. In this case, a gap between the thrust plate and a sleeve rotatably installed with regard to the shaft becomes a factor that may have an effect on rotational characteristics.

However, in a case in which the sleeve is installed with regard to the shaft, it may be difficult to manage the gap between the thrust plate and the sleeve. Further, in order to manage the gap, an assembly process may be complicated.

In addition, the sleeve rotatably installed with regard to the shaft forms a bearing clearance together therewith. This bearing clearance is filled with a lubricating fluid. However, at the time of an external impact, the lubricating fluid may be leaked to the outside, such that rotational characteristics may be deteriorated.

That is, the development of a structure of a shaft-fixed type spindle motor capable of reducing leakage of a lubricating fluid at the time of an external impact is required.

### SUMMARY OF THE INVENTION

An aspect of the present invention provides a spindle motor having an easily managed gap between a thrust plate and a sleeve.

Another aspect of the present invention provides a spindle motor capable of reducing a leakage of a lubricating fluid at the time of an external impact.

According to an aspect of the present invention, there is provided a spindle motor including: a shaft having a lower end portion fixed into a base member; a thrust plate fixed to the shaft; an upper sleeve disposed above the thrust plate and forming a first bearing clearance with the shaft; a lower sleeve disposed below the thrust plate and forming a second bearing clearance with the shaft; and a rotor hub rotating together with the upper and lower sleeves, wherein the upper sleeve includes an extension part extended toward the lower sleeve, and the lower sleeve includes a clearance adjusting part disposed to face the extension part when being coupled to the upper sleeve and extended toward the upper sleeve.

The extension part may have an outer peripheral surface inclined so as to form a liquid-vapor interface with an inner peripheral surface of the clearance adjusting part.

The upper sleeve may include a communication groove formed therein in order to allow a space formed by the outer peripheral surface of the extension part and the inner peripheral surface of the clearance adjusting part to be in communication with the outside.

The communication groove may be formed in a lower surface and an outer peripheral surface of the upper sleeve.

The upper sleeve may include a communication hole formed therein in order to allow a space formed by the outer peripheral surface of the extension part and the inner peripheral surface of the clearance adjusting part to be in communication with the outside.

Each of the upper and lower sleeves may include a dynamic pressure groove formed in an inner surface thereof in order to generate fluid dynamic pressure in a radial direction.

The thrust plate may be fixed to the shaft in such a manner as to be disposed below the extension part, inwardly of the clearance adjusting part.

A sum of a clearance between an upper surface of the thrust plate and the extension part and a clearance between a lower surface of the thrust plate and an upper surface of the lower sleeve may be the same as a difference in length between the clearance adjusting part and the extension part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is a perspective view showing an upper sleeve provided in the spindle motor according to the embodiment of the present invention;

FIGS. 3 through 5 are views showing an assembling process of a spindle motor according to the embodiment of the present invention;

FIG. 6 is a schematic cross-sectional view showing a spindle motor according to another embodiment of the present invention; and

FIG. 7 is a perspective view showing an upper sleeve provided in the spindle motor according to another embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

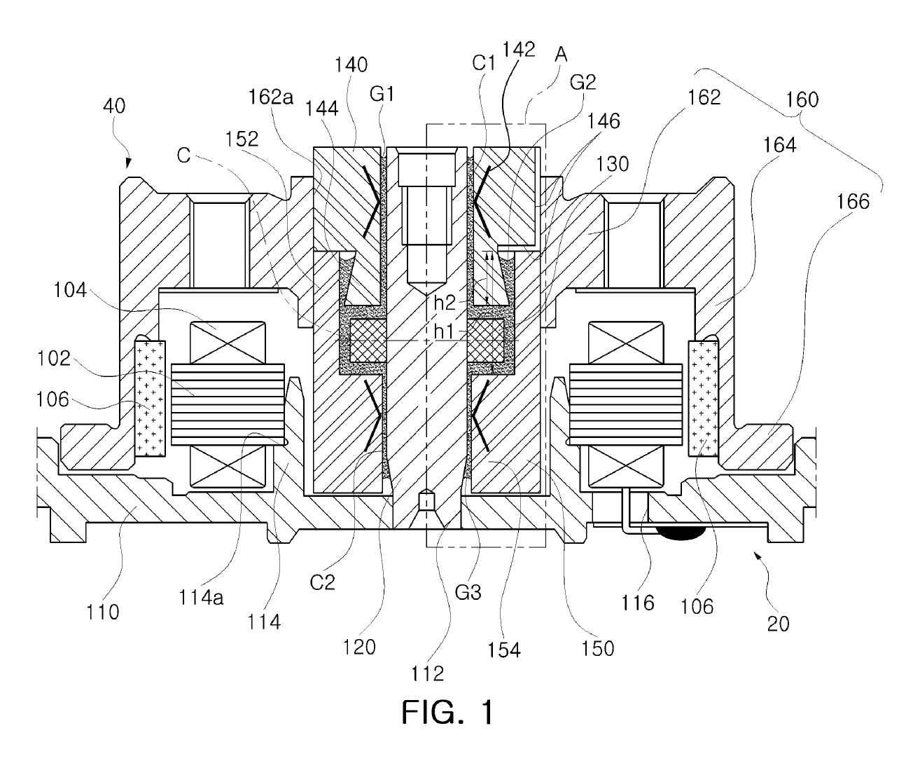

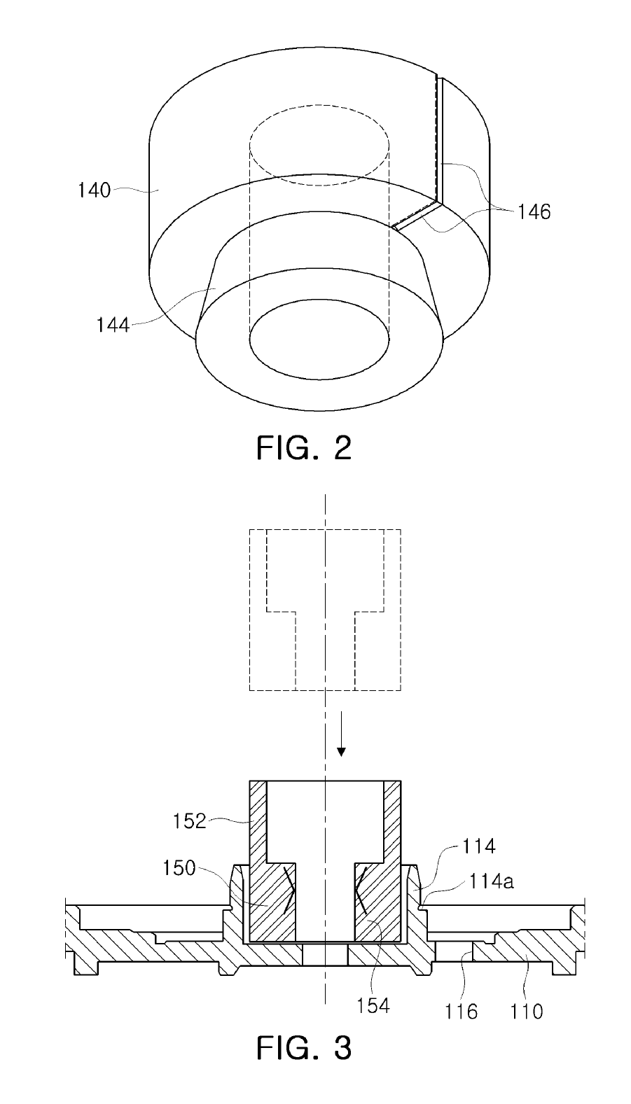

FIG. 1 is a schematic cross-sectional view showing a spindle motor according to an embodiment of the present invention; and FIG. 2 is a perspective view showing an upper sleeve provided in the spindle motor according to the embodiment of the present invention.

Referring to FIGS. 1 and 2, a spindle motor 100 according to the embodiment of the present invention may include a base member 110, a shaft 120, a thrust plate 130, an upper sleeve 140, a lower sleeve 150, and a rotor hub 160.

Meanwhile, the spindle motor 100 may be a motor used in an information recording and reproducing device such as a hard disk driving device for a server, or the like.

In addition, the spindle motor 100 according to the embodiment of the present invention may be mainly configured of a stator 20 and a rotor 40.

The stator 20, which means all fixed members with the exception of rotating members, may include the base member 110, the shaft 120, the thrust plate 130, a stator core 102, and the like.

In addition, the rotor 40, which means members rotating based on the shaft 120, may include the upper sleeve 140, the lower sleeve 150, the rotor hub 160, and the like.

The base member 110 may have an installation hole 112 formed therein so that a lower end portion of the shaft 120 may be fixed thereinto.

In addition, the base member 110 may include amounting part 114 protruded so as to be disposed in the vicinity of the installation hole 112 and having the stator core 102 fixed to an outer peripheral surface thereof. Meanwhile, the stator core 102 may have a coil 104 wound therearound, and one end portion of the coil 104 wound around the stator core 102 may be led to the outside through a lead hole 116 of the base member 110.

Further, the mounting part 114 may include the lower sleeve 150 inserted therein.

The shaft 120 has the lower end portion fixed into the base member 110. That is, the lower end portion of the shaft 120 may be inserted into and fixed into the installation hole 112 of the base member 110.

The thrust plate 130 may be fixed to the shaft 120. In other words, the thrust plate 130 may be fixed to a central portion of the shaft 120. In addition, although not shown in the accompanying drawings, a thrust dynamic pressure groove (not shown) pumping a filled lubricating fluid at the time of rotation of the rotor 40 to thereby generate thrust fluid dynamic pressure may be formed in at least one of a lower surface and an upper surface of the thrust plate 130.

Meanwhile, the thrust plate 130 may have a circular ring shape.

As described above, since the thrust plate 130 may be fixed to the central portion of the shaft 120, a bearing span length may increase. The detailed description thereof will be provided below.

The upper sleeve 140 may be disposed above the thrust plate 130 and form a first bearing clearance C1 with the shaft 120. In addition, the first bearing clearance C1 may be filled with the lubricating fluid.

In addition, the upper sleeve 140 may rotate together with the rotor hub 160 at the time of rotation of the rotor hub 160. To this end, an outer surface of the upper sleeve 140 may be bonded to an inner surface of the rotor hub 160.

Meanwhile, the upper sleeve 140 may include a dynamic pressure groove 142 formed in an inner surface thereof in order to generate fluid dynamic pressure in a radial direction.

In addition, an upper portion of the dynamic pressure groove 142 may be provided with an interface between the lubricating fluid and air, that is, a liquid-vapor interface G1.

Further, the upper sleeve 140 may have an extension part 144 extended toward the lower sleeve 150. As an example, the extension part 144 may have an outer peripheral surface inclined so as to form an interface between the lubricating fluid and air, that is, a second liquid-vapor interface G2.

The detailed description thereof will be provided below.

In addition, the upper sleeve 140 may include a communication groove 146 formed therein. That is, the communication groove 146 may be formed in a lower surface of the upper sleeve 140, more specifically, in the lower surface of the upper sleeve 140 and an outer peripheral surface of the sleeve 140 disposed outside the extension part 144.

Therefore, air pressure of a space in which the second liquid-vapor interface G2 is formed is the same as that of the outside, such that the second liquid-vapor interface G2 may be provided.

Here, terms with respect to directions will be first defined. As viewed in FIG. 1, an axial direction refers to a vertical direction, that is, a direction from the lower end portion of the shaft 120 toward an upper end portion thereof or a direction from the upper end portion of the shaft 120 toward the lower end portion thereof, a radial direction refers to a horizontal direction, that is, a direction from an outer peripheral surface of the rotor hub 160 toward the shaft 120 or from the shaft 120 toward the outer peripheral surface of the rotor hub 160, and a circumferential direction refers to a rotation direction along the outer peripheral surface of the rotor hub 160.

The lower sleeve 150 may be disposed under the upper sleeve 140 and form a second bearing clearance C2 with the shaft 120.

Further, the lower sleeve 150 may have a clearance adjusting part 152 disposed to face the extension part 144 when being assembled with the upper sleeve 140 and extended toward the upper sleeve 140.

Meanwhile, the lower sleeve 150 and the upper sleeve 140 may be fixedly coupled to each other so that an upper surface of the clearance adjusting part 152 is bonded to the lower surface of the upper sleeve 140.

Therefore, a clearance formed between the upper and lower sleeves 140 and 150 and the thrust plate 130 disposed between the upper and lower sleeves 140 and 150 may be maintained to be constant.

That is, the clearance formed by the thrust plate 130 and the upper and lower sleeves 140 and 150 may be managed only by fixedly coupling the lower sleeve 150 and the upper sleeve 140 to each other such that the upper surface of the clearance adjusting part 152 is bonded to the lower surface of the upper sleeve 140.

Here, the clearance in the axial direction formed by the thrust plate 130 and the upper and lower sleeves 140 and 150 may have a distance of h1-h2.

In addition, an inner peripheral surface of the clearance adjusting part 152 and the outer peripheral surface of the extension part 144 may have the second liquid-vapor interface G2 formed therebetween. To this end, the upper sleeve 140 may include the communication groove 146 formed therein in order to allow a space formed by the inner peripheral surface of the clearance adjusting part 152 and the outer peripheral surface of the extension part 144 to be in communication with the outside.

Therefore, the space formed by the inner peripheral surface of the clearance adjusting part 152 and the outer peripheral surface of the extension part 144 is in an atmospheric pressure state, such that the second liquid-vapor interface G2 may be formed.

In addition, the thrust plate 140 may be disposed inwardly of the clearance adjusting part 152 of the lower sleeve 150 in the radial direction.

Meanwhile, a space formed by the upper and lower sleeves 140 and 150 may also be filled with the lubricating fluid. Therefore, the thrust plate 130 may be immersed in the lubricating fluid.

In addition, a lower end portion of the lower sleeve 150, a lower portion of a dynamic pressure groove 154 may be provided with an interface between the lubricating fluid and air, that is, a third liquid-vapor interface G3.

Further, an upper end portion of an outer peripheral surface of the clearance adjusting part 152 may be bonded to an inner peripheral surface of the rotor hub 160. Therefore, at the time of rotation of the rotor hub 160, the lower sleeve 150 may rotate together with the upper sleeve 140 and the rotor hub 160.

In addition, the lower sleeve 150 may include the dynamic pressure groove 154 formed in an inner surface thereof in order to generate fluid dynamic pressure in the radial direction. That is, the lower sleeve 150 may include the dynamic pressure groove 154 formed in the inner surface thereof so as to generate the fluid dynamic pressure by pumping the lubricating fluid filled in the second bearing clearance C2 at the time of the rotation of the lower sleeve 150.

As described above, since the thrust plate 130 is disposed between the dynamic pressure groove 142 of the upper sleeve 140 and the dynamic pressure groove 154 of the lower sleeve 150, an interval between the dynamic pressure grooves 142 and 154 may increase. Therefore, a bearing span length may increase, such that rotational characteristics may be further improved.

Meanwhile, although the embodiment of the present invention describes a case in which the extension part 144 of the upper sleeve 140 is disposed inwardly of the clearance adjusting part 152 of the lower sleeve 150 by way of example, the present invention is not limited thereto. For example, the extension part 144 of the upper sleeve 140 and the clearance adjusting part 152 of the lower sleeve 150 may also be formed in a reversed manner.

That is, the upper sleeve 140 may be provided with the clearance adjusting part, and the lower sleeve 150 may be provided with the extension part.

The rotor hub 160 may rotate together with the upper and lower sleeves 140 and 150.

In addition, the rotor hub 160 may include a body 162 having a through-hole 162a formed at the center thereof, a magnet mounting part 164 extended downwardly from an edge of the body in the axial direction, and a disk mounting part 166 extended from a distal end of the magnet mounting part 164 outwardly in the radial direction.

Meanwhile, an inner surface of the body 162 may be bonded to the outer surface of the upper sleeve 140 and an outer surface of the clearance adjusting part 152 of the lower sleeve 150.

That is, the inner surface of the body 162 may be bonded to the upper and lower sleeves 140 and 150 so that the upper and lower sleeves 140 and 150 may rotate together with the rotor hub 160 at the time of the rotation of the rotor hub 160.

In addition, the magnet mounting part 164 may include a driving magnet 106 installed on an inner peripheral surface thereof. The driving magnet 106 may be installed on the magnet mounting part 164 so as to be disposed to face a front end of the stator core 102.

Here, rotational driving of the rotor hub 160 will be schematically described. When power is supplied to the coil 104 wound around the stator core 102, driving force capable of rotating the rotor hub 160 may be generated by electromagnetic interaction between the driving magnet 106 and the stator core 102 having the coil 104 wound therearound.

Therefore, the rotor hub 160 rotates, such that the upper and lower sleeves 140 and 150 to which the rotor hub 160 is bonded may rotate together with the rotor hub 160.

As described above, the clearance formed by the upper and lower sleeves 140 and 150 and the thrust plate 130 may be managed by the extension part 144 of the upper sleeve 140 and the clearance adjusting part 152 of the lower sleeve 150, whereby an assembling process may be more easily performed.

In addition, since the second liquid-vapor interface G2 may be formed in the space formed by the extension part 144 and the clearance adjusting part 152, the leakage of the lubricating fluid to the outside at the time of an external impact may be further reduced.

That is, since the lubricating fluid may move in the space formed by the extension part 144 and the clearance adjusting part 152 at the time of the external impact, a movement path of the lubricating fluid increases, whereby the leakage of the lubricating fluid may be reduced.

Hereinafter, an assembling process of a spindle motor according to the embodiment of the present invention will be described with reference to the accompanying drawings.

FIGS. 3 through 5 are views showing an assembling process of a spindle motor according to the embodiment of the present invention.

First referring to FIG. 3, the lower sleeve 150 is mounted in the mounting part 114 of the base member 110. At this time, the installation hole 112 of the base member 110 is disposed under an opening part of the lower sleeve 150.

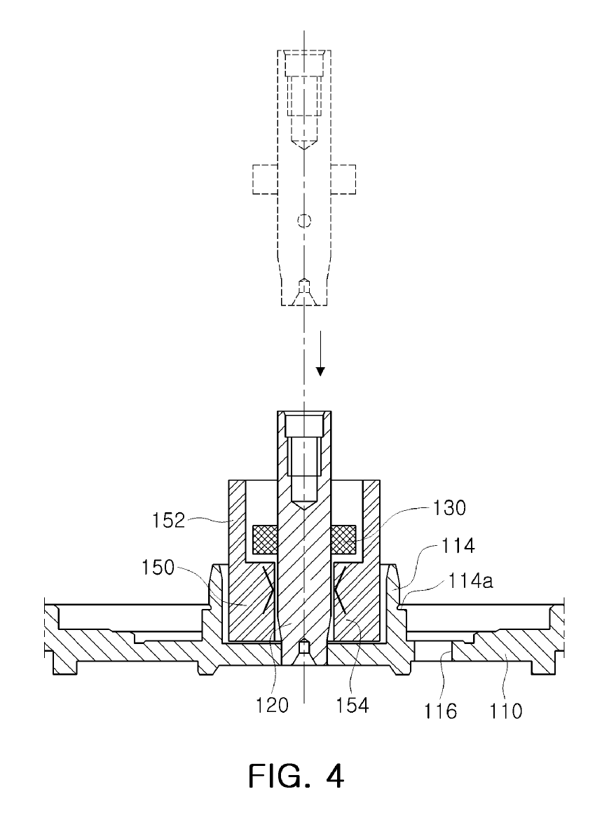

Then, as shown in FIG. 4, the shaft 120 may be fixed into the base member 110. That is, the shaft 120 may be fixed into the base member 110 so that the lower end portion thereof is inserted into the installation hole 112 of the base member 110.

In addition, the lower end portion of the shaft 120 may fixed into the installation hole 112 of the base member 110.

Therefore, the clearance formed by the upper surface of the lower sleeve 150 and the lower surface of the thrust plate 130 may be managed to be constant.

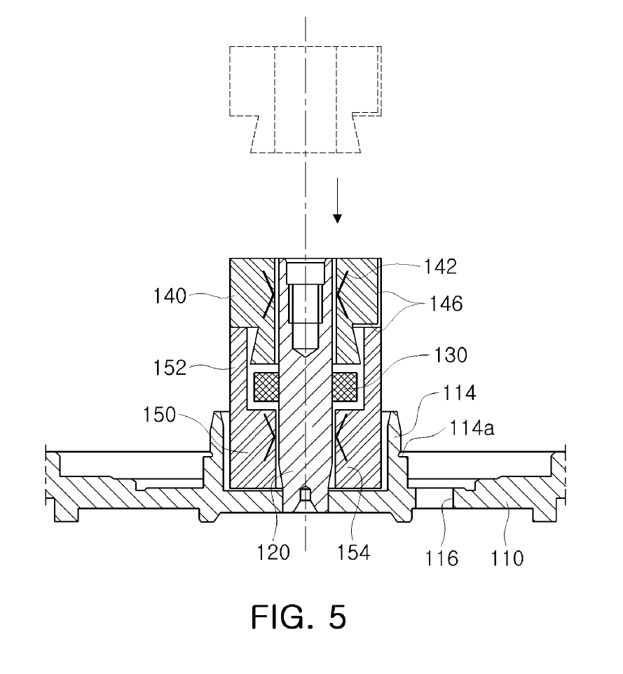

Next, as shown in FIG. 5, the upper sleeve 140 is mounted on the shaft 120. At this time, the lower sleeve 150 may be installed such that the upper surface of the clearance adjusting part 152 thereof is bonded to the lower surface of the upper sleeve 140.

Therefore, the clearance formed between the upper and lower sleeves 140 and 150 and the thrust plate 130 disposed between the upper and lower sleeves 140 and 150 may be maintained to be constant.

That is, the clearance formed by the thrust plate 130 and the upper and lower sleeves 140 and 150 may be managed only by fixedly coupling the lower sleeve 150 and the upper sleeve 140 to each other such that the upper surface of the clearance adjusting part 152 is bonded to the lower surface of the upper sleeve 140.

Here, the clearance in the axial direction formed by the thrust plate 130 and the upper and lower sleeves 140 and 150 may have the distance of h1-h2.

As described above, the clearance formed by the upper and lower sleeves 140 and 150 and the thrust plate 130 may be managed by the extension part 144 of the upper sleeve 140 and the clearance adjusting part 152 of the lower sleeve 150, whereby an assembling process may be more easily performed.

In addition, since the second liquid-vapor interface G2 may be formed in the space formed by the extension part 144 and the clearance adjusting part 152, the leakage of the lubricating fluid to the outside at the time of an external impact may be further reduced.

That is, since the lubricating fluid may move in the space formed by the extension part 144 and the clearance adjusting part 152 at the time of the external impact, a movement path of the lubricating fluid increases, whereby the leakage of the lubricating fluid may be reduced.

Hereinafter, a spindle motor according to another embodiment of the present invention will be described with reference to the accompanying drawings. However, a detailed description of the same components as the above-mentioned components will be omitted and be replaced by the above-mentioned description.

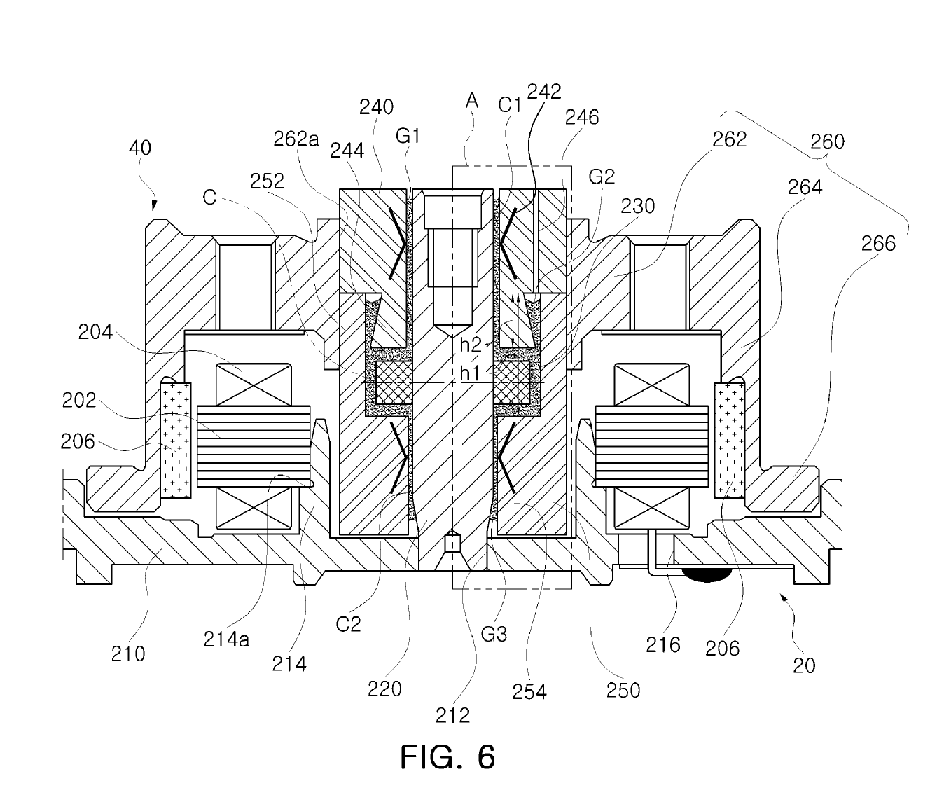

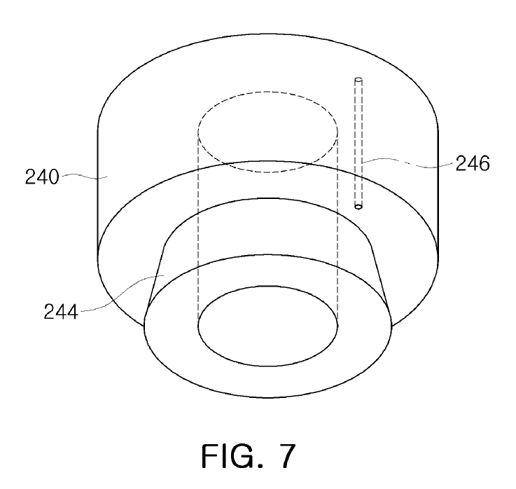

FIG. 6 is a schematic cross-sectional view showing a spindle motor according to another embodiment of the present invention; and FIG. 7 is a perspective view showing an upper sleeve provided in the spindle motor according to another embodiment of the present invention.

Referring to FIGS. 6 and 7, a spindle motor 200 according to another embodiment of the present invention may include a base member 210, a shaft 220, a thrust plate 230, an upper sleeve 240, a lower sleeve 250, and a rotor hub 260 by way of example.

Meanwhile, the base member 210, the shaft 220, the thrust plate 230, the upper sleeve 240, the lower sleeve 250, and the rotor hub 260 according to another embodiment of the present invention have the same configurations as those of the base member 110, the shaft 120, the thrust plate 130, the upper sleeve 140, the lower sleeve 150, and the rotor hub 160 of the spindle motor 100 according to the foregoing embodiment of the present invention with the exception of a configuration to be described below.

Therefore, hereinafter, a detailed description will be omitted and be replaced with the above-mentioned description.

Meanwhile, the upper sleeve 240 may be disposed above the thrust plate 230 and form the first bearing clearance C1 with the shaft 220. In addition, the first bearing clearance C1 may be filled with the lubricating fluid.

In addition, the upper sleeve 240 may rotate together with the rotor hub 260 at the time of rotation of the rotor hub 260. To this end, an outer surface of the upper sleeve 240 may be installed to be bonded to an inner surface of the rotor hub 260.

Meanwhile, the upper sleeve 240 may have an extension part 244 extended downwardly from a lower surface thereof in the axial direction. The extension part 244 may have an outer peripheral surface inclined so as to form an interface between the lubricating fluid and air, that is, the second liquid-vapor interface G2.

In addition, the upper sleeve 240 may include a communication hole 246 formed therein. That is, the upper sleeve 240 may include the communication hole 246 extended from the lower surface thereof toward an upper surface thereof and disposed outwardly of the extension part 244 in the radial direction.

Therefore, air pressure of a space in which the second liquid-vapor interface G2 is formed is the same as that of the outside, such that the second liquid-vapor interface G2 may be provided.

More specifically, the lower sleeve 250 may be provided with a clearance adjusting part 252, and the second liquid-vapor interface G2 may be formed between an inner peripheral surface of the clearance adjusting part 252 and an outer peripheral surface of the extension part 244. To this end, the upper sleeve 240 may include the communication hole 246 formed therein in order to allow a space formed by the inner peripheral surface of the clearance adjusting part 252 and the outer peripheral surface of the extension part 244 to be in communication with the outside.

Therefore, the space formed by the inner peripheral surface of the clearance adjusting part 252 and the outer peripheral surface of the extension part 244 is in an atmospheric pressure state, such that the second liquid-vapor interface G2 may be formed.

As described above, a clearance formed by the upper and lower sleeves 240 and 250 and the thrust plate 230 may be managed by the extension part 244 of the upper sleeve 240 and the clearance adjusting part 252 of the lower sleeve 250, whereby an assembling process may be more easily performed.

In addition, since the second liquid-vapor interface G2 may be formed in the space formed by the extension part 244 and the clearance adjusting part 252, the leakage of the lubricating fluid to the outside at the time of an external impact may be further reduced.

That is, since the lubricating fluid may move in the space formed by the extension part 244 and the clearance adjusting part 252 at the time of the external impact, a movement path of the lubricating fluid increases, whereby the leakage of the lubricating fluid may be reduced.

As set forth above, according to the embodiments of the present invention, the upper and lower sleeves are installed such that the clearance between the upper and lower sleeves and the thrust plate are constant through the extension part of the upper sleeve and the clearance adjusting part of the lower sleeve, whereby rotational characteristics can be improved.

In addition, the liquid-vapor interface is formed through the extension part of the upper sleeve and the clearance adjusting part of the lower sleeve, whereby the leakage of the lubricating fluid at the time of the external impact can be reduced.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a shaft having a lower end portion fixed into a base member;
a thrust plate fixed to the shaft;
an upper sleeve disposed above the thrust plate and forming a first bearing clearance with the shaft;
a lower sleeve disposed below the thrust plate and forming a second bearing clearance with the shaft; and
a rotor hub rotating together with the upper and lower sleeves,
wherein the upper sleeve includes an extension part extended toward the lower sleeve, and
the lower sleeve includes a clearance adjusting part disposed to face the extension part when being coupled to the upper sleeve and extended toward the upper sleeve.

2. The spindle motor of claim 1, wherein the extension part has an outer peripheral surface inclined so as to form a liquid-vapor interface with an inner peripheral surface of the clearance adjusting part.

3. The spindle motor of claim 2, wherein the upper sleeve includes a communication groove formed therein in order to allow a space formed by the outer peripheral surface of the extension part and the inner peripheral surface of the clearance adjusting part to be in communication with the outside.

4. The spindle motor of claim 3, wherein the communication groove is formed in a lower surface and an outer peripheral surface of the upper sleeve.

5. The spindle motor of claim 2, wherein the upper sleeve includes a communication hole formed therein in order to allow a space formed by the outer peripheral surface of the extension part and the inner peripheral surface of the clearance adjusting part to be in communication with the outside.

6. The spindle motor of claim 1, wherein each of the upper and lower sleeves includes a dynamic pressure groove formed in an inner surface thereof in order to generate fluid dynamic pressure in a radial direction.

7. The spindle motor of claim 1, wherein the thrust plate is fixed to the shaft in such a manner as to be disposed below the extension part, inwardly of the clearance adjusting part.

8. The spindle motor of claim 1, wherein a sum of a clearance between an upper surface of the thrust plate and the extension part and a clearance between a lower surface of the thrust plate and an upper surface of the lower sleeve is the same as a difference in length between the clearance adjusting part and the extension part.
